(19) United States
(12) Patent Application Publication
(10) Pub. No.: US 2018/0249094 A1
(43) Pub. Date: Aug. 30, 2018

(54) Wireless Camera System

(71) Applicants: Ryan Mikah Fuller, Costa Mesa, CA (US); Tamio Lucien Stehrenberger, Costa Mesa, CA (US); Shahin Amirpour, Huntington Beach, CA (US); John McGuinness, Huntington Beach, CA (US); Christopher Lawrence Greaves, Huntington Beach, CA (US); Lane Gearle Brooks, Highland, UT (US)

(72) Inventors: Ryan Mikah Fuller, Costa Mesa, CA (US); Tamio Lucien Stehrenberger, Costa Mesa, CA (US); Shahin Amirpour, Huntington Beach, CA (US); John McGuinness, Huntington Beach, CA (US); Christopher Lawrence Greaves, Huntington Beach, CA (US); Lane Gearle Brooks, Highland, UT (US)

(73) Assignee: Opkix, Inc, Costa Mesa, CA (US)

(21) Appl. No.: 15/904,380

(22) Filed: Feb. 25, 2018

Related U.S. Application Data
(60) Provisional application No. 62/463,759, filed on Feb. 27, 2017.

(51) Int. Cl. H04N 5/28; H04N 5/225

(52) U.S. Cl. CPC H04N 5/28; H04N 7/183; H04N 5/2253; H04N 5/2252

(57) ABSTRACT

The present invention relates to wireless camera systems including a camera module and power module which are configured to wireless transmit data to a portable computing device. The camera module may be configured to generate data from an image sensor or microphone. The electrical input may be configured to receive a direct current to charge the primary battery and the battery receptacle may include both a physical camera receptacle and an electrical camera coupler. In a first embodiment, the camera module may further include a wireless communication module configured to wirelessly transmit the data to the portable computer device in the separated state. In a second embodiment, the power module may be configured to receive the data from the camera module in the coupled state and wirelessly transmit the data to the portable computer device in the coupled state via a wireless communication module.

### RELATED APPLICATIONS

This application claims priority to U.S. provisional application Ser. No. 62/463,759 filed Feb. 27, 2017 the contents of which are incorporated by reference.

### FIELD OF THE INVENTION

The invention generally relates to wireless camera systems. In particular, the present invention relates to a wireless camera system that includes a camera module and a power module configured to independently or cooperatively transmit data wirelessly to a portable computer device system.

### BACKGROUND OF THE INVENTION

Portable computing devices (PCD) such as smartphones, tablet phones, tablets, etc. have become ubiquitous among industrialized populations. PCDs are characterized by independent communication and computer processing. For example, PCDs include a radio capable of communicating wirelessly over one or more data frequencies (i.e. cellular, Bluetooth, Wi-Fi). PCDs further include computer components which enable the PCD to function independently of other computing devices, including processors, power sources, memory modules, etc.

PCDs include a variety of input components such as cameras, touch screen, biometric sensors, connectors, microphones, etc. which enable a user to input data into the PCD via various mediums. For example, a user may input video or photo data via an integrated camera within the PCD. The PCD may then process and display the video or photo data on an output component such as a display screen. The processing of data may include selective manipulation via various applications, or apps.

Conventional integrated PCD-based camera components are limited in their operation and utility. Most PCDs include one or more integrated photo and/or video camera components. However, the integrated camera components are inherently restricted to a location on the PCD device. Therefore, to capture both an image and view the real-time input of the photo/video component on the display screen of the PCD, a user is inherently limited in positioning and orienting the photo/video component. Likewise, video capture over a period of time is cumbersome by requiring a user to physically position the entire PCD in a manner to capture the desired video view angle.

External camera components such as GO PRO® type devices provide convenient positioning but then require cumbersome data transfer to one or more computing devices. Many external components transfer data onto digital mediums that cannot be directly transferred into a PCD without additional components (i.e. SD Cards). Thus, conventional external cameras do not efficiently transmit data to the PCD while allowing optimum positioning for data recording.

Therefore, there is a need in the industry for a wireless camera system that integrates with a portable computing device to provide optimum positioning and efficient wireless data transfer.

### SUMMARY OF THE INVENTION

The present invention relates to wireless camera systems, including a camera module and power module which are configured to wireless transmit data to a portable computing device. The portable computer device may be a smartphone, tablet, or tablet phone having a total volume smaller than twenty cubic inches. The camera module may have an outer dimension smaller than three cubic inches and may further include an electrical coupler, secondary battery, lens, image sensor, circuit board, and microphone. The camera module may be configured to generate data from the image sensor or microphone. The power module may have an outer dimension smaller than twenty cubic inches and may further include a primary battery, an electrical input, and a camera receptacle. The electrical input may be configured to receive a direct current to charge the primary battery, and the battery receptacle may include both a physical camera receptacle and an electrical camera coupler. The system may include a coupled state in which the camera module is disposed within the physical camera receptacle and an electrical coupling between the electrical coupler of the camera module and the electrical camera coupler of the power module. The system may include a separated state in which the camera module is physically separate or independent of the power module. The portable computer device may be configured to wirelessly receive the data generated by the camera module. In a first embodiment, the camera module may further include a wireless communication module configured to wirelessly transmit the data to the portable computer device in the separated state. In a second embodiment, the power module may be configured to receive the data from the camera module in the coupled state and wirelessly transmit the data to the portable computer device in the coupled state via a wireless communication module.

Embodiments of the present invention represent a significant advance in the field of wireless camera systems. Conventional external camera systems generally fail to include an integrated wireless transmission system, thereby making the data transfer process cumbersome. Likewise, some external camera systems require a physical wire between the camera module and the portable computer system, making data capture cumbersome. Embodiments of the present invention provide a portable camera system that optimizes both functionality in data capture and transfer to a portable computer device. The first embodiment relates a “smart camera” in which both the data capture and data transmission are handled by the camera module. In the first embodiment, the power module acts as a “dumb component,” serving only to charge the battery in the camera module. The second embodiment relates to a “smart power module” in which the camera module must record the data as it's captured and then directly transfer the data to the power module via an electrical coupling. The power module may then wireless transmit the data to the portable computer device. The novel integration of the camera module and power module to both enable optimum camera functionality and data transfer functionality is not present in the prior art.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

The following description of the invention can be understood in light of the Figures, which illustrate specific aspects of the invention and are a part of the specification. Together with the following description, the Figures demonstrate and explain the principles of the invention. In the Figures, the physical dimensions may be exaggerated for clarity. The same reference numerals in different drawings represent the same element, and thus their descriptions will be omitted.

FIGS. 1A-C illustrate schematic views of a wireless camera system in accordance with a first embodiment of the present invention; and

FIGS. 2A-C illustrate schematic views of a wireless camera system in accordance with a second embodiment of the present invention.

### DETAILED DESCRIPTION OF THE INVENTION

The present invention relates to wireless camera systems, including a camera module and power module which are configured to wireless transmit data to a portable computing device. The portable computer device may be a smartphone, tablet, or tablet phone having a total volume smaller than twenty cubic inches. The camera module may have an outer dimension smaller than three cubic inches and may further include an electrical coupler, secondary battery, lens, image sensor, circuit board, and microphone. The camera module may be configured to generate data from the image sensor or microphone. The power module may have an outer dimension smaller than twenty cubic inches and may further include a primary battery, an electrical input, and a camera receptacle. The electrical input may be configured to receive a direct current to charge the primary battery, and the battery receptacle may include both a physical camera receptacle and an electrical camera coupler. The system may include a coupled state in which the camera module is disposed within the physical camera receptacle and an electrical coupling between the electrical coupler of the camera module and the electrical camera coupler of the power module. The system may include a separated state in which the camera module is physically separate or independent of the power module. The portable computer device may be configured to wirelessly receive the data generated by the camera module. In a first embodiment, the camera module may further include a wireless communication module configured to wirelessly transmit the data to the portable computer device in the separated state. In a second embodiment, the power module may be configured to receive the data from the camera module in the coupled state and wirelessly transmit the data to the portable computer device in the coupled state via a wireless communication module. Also, while embodiments are described in reference to a visual camera system, it will be appreciated that the teachings of the present invention are applicable to other areas, including but not limited to other sensing systems such as audio, position, motion, infrared, microscopic, etc.

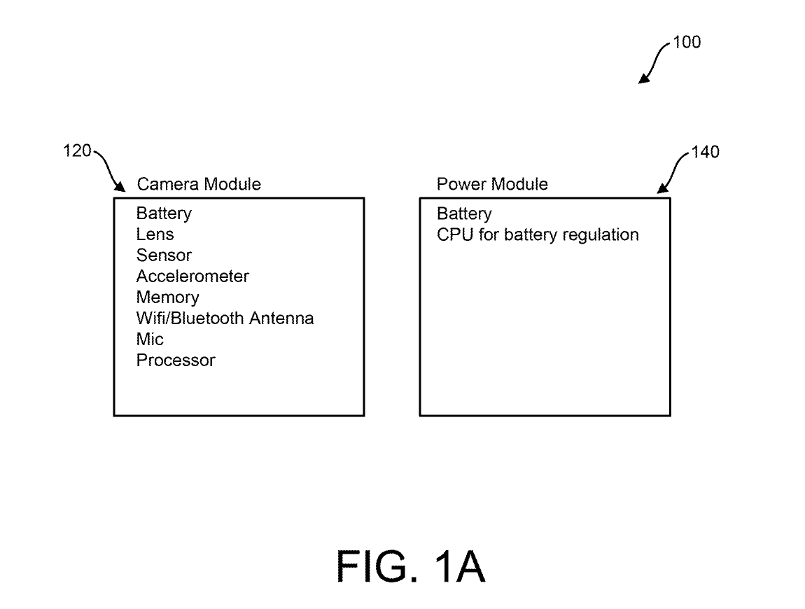

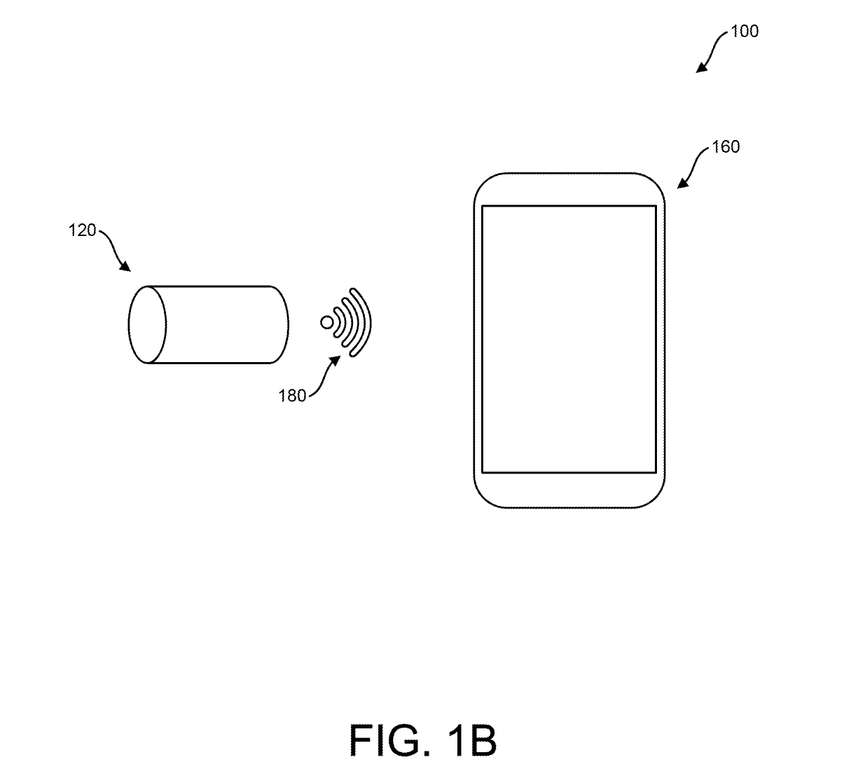

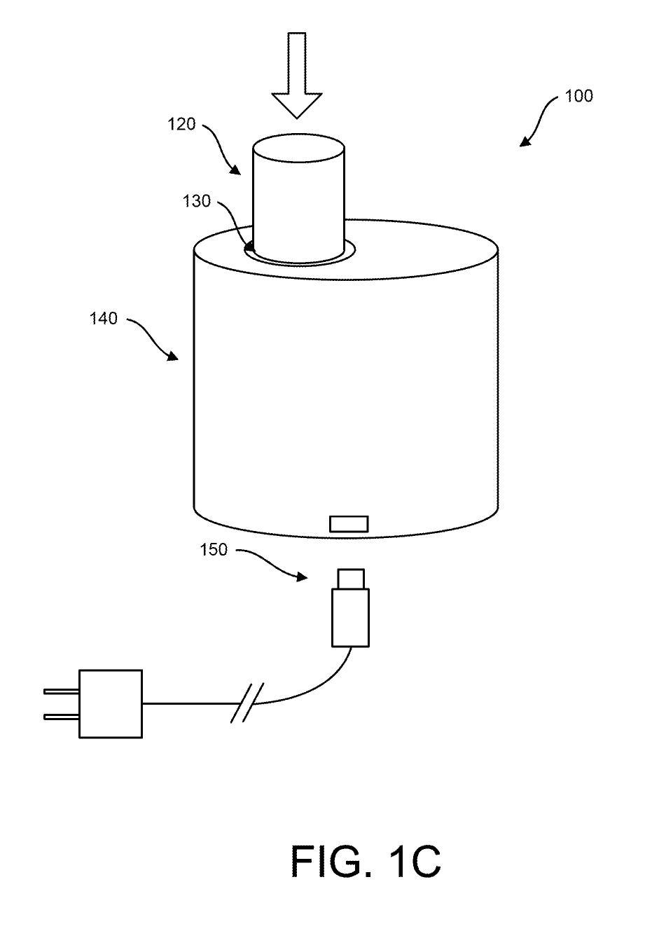

Reference is initially made to FIGS. 1A-C, which illustrate schematic views of a wireless camera system in accordance with a first embodiment of the present invention, designated generally at 100. The illustrated system 100 includes a portable computer device (PCD) 160, a camera module 120, and power module 140. The portable computer device 160 may be any small portable computing device that includes integrated wireless data transfer functionalities, a power source, a display screen, and at least one user input device. In addition, a PCD is defined as having an external form factor smaller than twenty cubic inches. Examples of a PCD include but are not limited to a smartphone, mini-computer, e-reader, tablet, or tablet phone. The camera module 120 is an external unit having a form factor smaller than three cubic inches. In the first embodiment, the camera module 120 may include a battery, lens, sensor, accelerometer, memory, wife/Bluetooth antenna, microphone, and/or a processor as illustrated in FIG. 1A. The components of the camera module are configured to capture audio, video, and positional data from the microphone, sensor, and accelerometer, respectively. The camera module 120 may further include an electrical coupler configured to engage with the power module. In the first embodiment, the power module 140 may include a battery and a CPU (central processing unit) as illustrated in FIG. 1A. The power module 140 may further include a camera receptacle comprising an electrical camera coupler and a physical camera receptacle.

In a separated state (FIG. 1B), the camera module 120 may be configured to wirelessly transmit data 180 to the PCD 160 via Wi-Fi or Bluetooth connectivity. The wireless transmission of the data 180 may be continuous or intermittent depending on the mode of transmission. Various well known data transfer protocols may be incorporated such as buffering, packaging, indexing, encrypting, etc. In addition, the wireless data transfer 180 may include 2-way communication, enabling the PCD 160 to affect the data capture and/or transfer. For example, the PCD 160 may instruct the camera to wirelessly send only audio data while recording video and position data.

In a coupled state (FIG. 1C), the camera module 120 is coupled with the power module 140 via the camera receptacle 130. The coupling between the camera module 120 and power module 140 includes both an electrical coupling and a physical coupling. The electrical coupling includes an electrical coupling between the electrical coupler of the camera module 120 and the electrical camera coupler of the power module 140. The physical coupling includes a physical coupling of the camera module 120 within the physical camera receptacle of the power module 140. In the illustrated embodiment, the physical camera receptacle is a recess configured to receive and support the outer substantially cylindrical shape of the camera module 120. It will be appreciated that the physical coupling between the camera module 120 and power module 140 is also configured to engage the electrical coupling between the camera module 120 and the power module 140. For example, the camera module 120 electrical coupler may be disposed on the illustrated bottom end, and the power module camera electrical coupler may be disposed on the interior bottom of the cylindrical recess. Therefore, the positioning of the camera module 120 within the recess of the power module 140 will automatically engage the electrical coupling therebetween. The power module 140 further includes an electrical input 150 through which the power module's battery may be charged. The electrical input 150 may be any type of electrical coupler such as a USB, mini USB, micro USB, etc. A user may selectively charge the power module's battery by connecting the electrical input 150 to a power source such as an AC outlet or other DC power supply (i.e. USB power outlet).

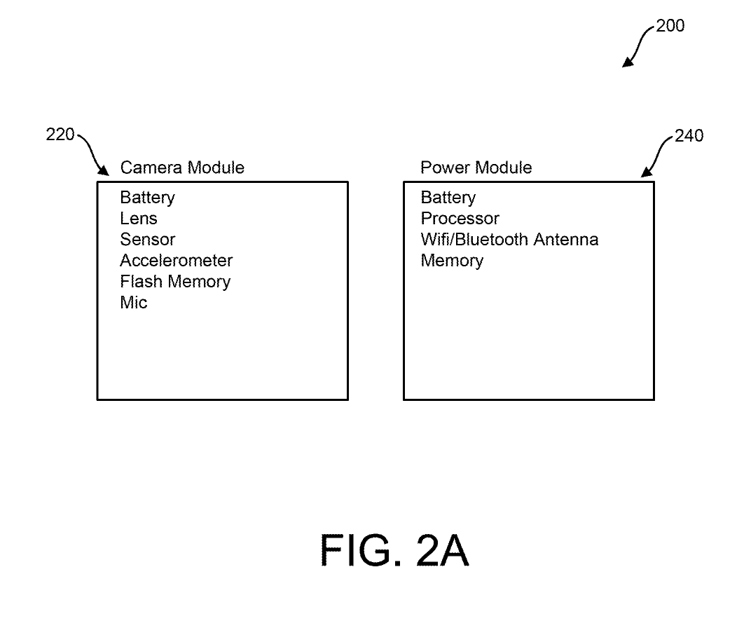

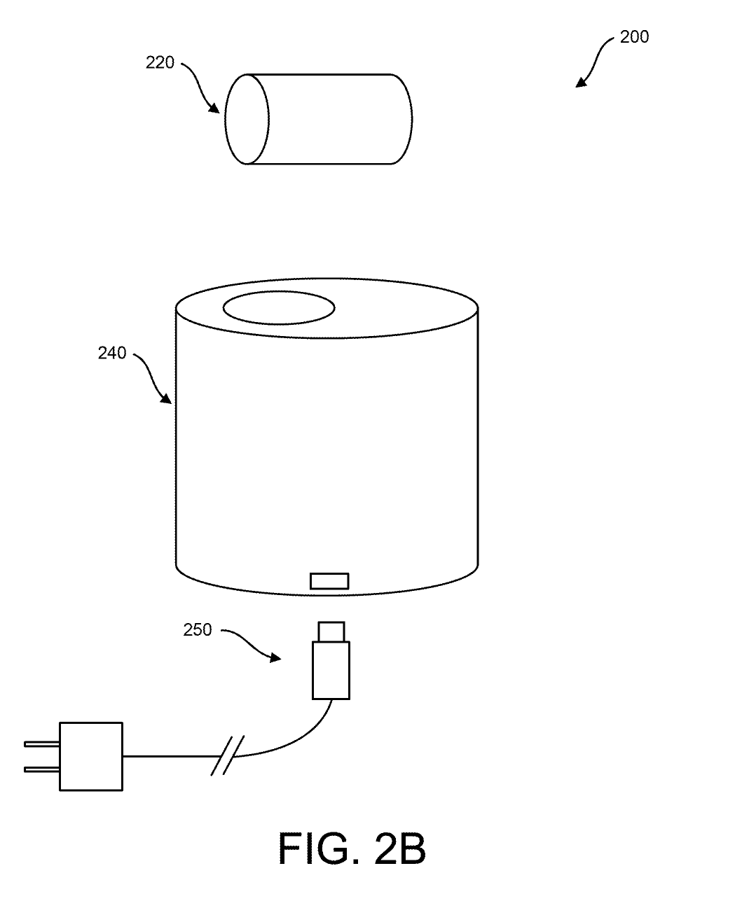

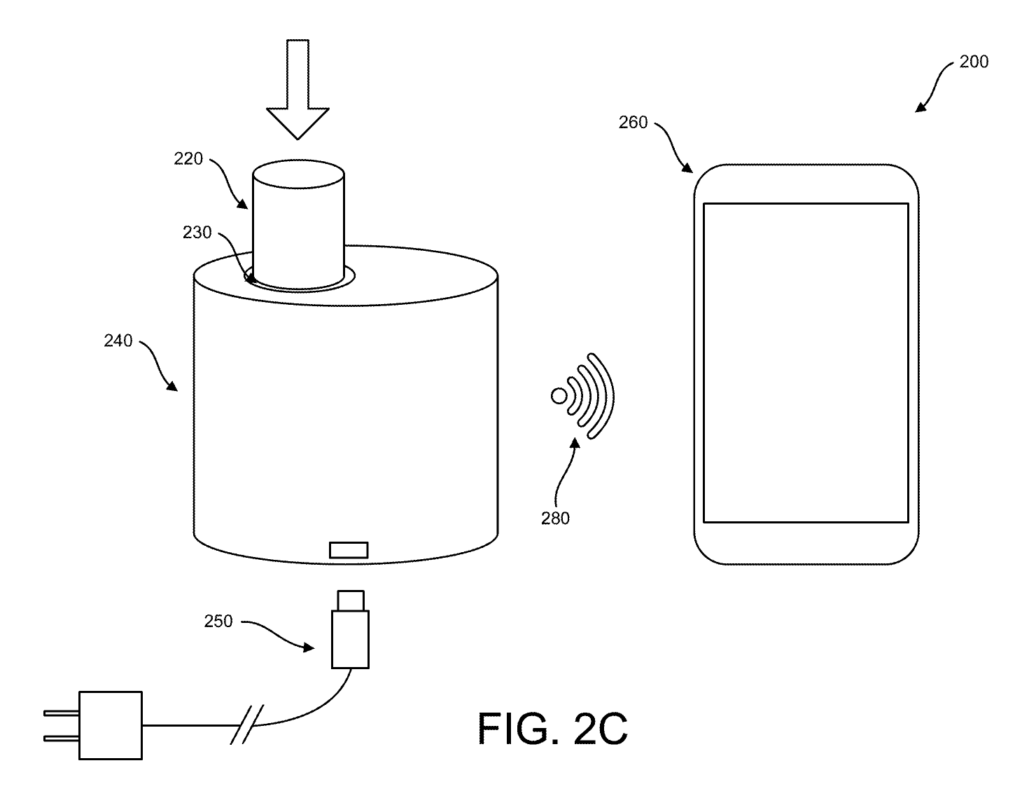

Reference is next made to FIGS. 2A-C, which illustrate schematics of a second embodiment of a wireless camera system, designated generally at 200. The illustrated system 200 also includes a portable computer device (PCD) 260, a camera module 220, and power module 260. The portable computer device 260 may be any small portable computing device that includes integrated wireless data transfer functionalities, a power source, a display screen, and at least one user input device. In addition, a PCD is defined as having an external form factor smaller than twenty cubic inches. Examples of a PCD include but are not limited to a smartphone, mini-computer, e-reader, tablet, or tablet phone. The camera module 220 is an external unit having a form factor smaller than three cubic inches. In the second embodiment, the camera module 220 may include a battery, lens, sensor, accelerometer, memory, and microphone as illustrated in FIG. 2A. The components of the camera module are configured to capture audio, video, and position data from the microphone, sensor, and accelerometer, respectively. The camera module 220 may further include an electrical coupler configured to engage with the power module 240. In the second embodiment, the power module 240 may include a battery, processor, Wi-Fi/Bluetooth antenna, and memory as illustrated in FIG. 2A. The power module 240 may further include a camera receptacle comprising an electrical camera coupler and a physical camera receptacle.

In a separated state (FIG. 2B), the camera module 220 may be configured to independently capture and store data. The camera module 220 may include one or more buttons to allow a user to control the data capture and storage of the camera module 220. For example, a user may be able to selectively engage/disengage the capture and recording of audio, video, and/or position data by pressing one or more buttons located externally on the camera module (not shown). In addition, the camera module 220 may utilize one or more sensors to control parameters. For example, an accelerometer may be used to correlate movement of the camera module 220 with an activation of the capture and recording of audio, video, and/or position data. In the separated state, the power module 240 may be electrically connected to an external power source via an electrical input 250. The power module 240 further includes an electrical input 250 through which the power module's battery may be charged. The electrical input 250 may be any type of electrical coupler such as a USB, mini USB, micro USB, etc. A user may selectively charge the power module's battery by connecting the electrical input 250 to a power source such as an AC outlet or other DC power supply (i.e. USB power outlet).

In a coupled state (FIG. 1C), the camera module 220 is coupled with the power module 240 via the camera receptacle 230. The coupling between the camera module 220 and power module 240 includes both an electrical coupling and a physical coupling. The electrical coupling includes an electrical coupling between the electrical coupler of the camera module 220 and the electrical camera coupler of the power module 240. The physical coupling includes a physical coupling of the camera module 220 within the physical camera receptacle of the power module 240. In the illustrated embodiment, the physical camera receptacle is a recess configured to receive and support the substantially cylindrical outer shape of the camera module 220. It will be appreciated that the physical coupling between the camera module 220 and power module 240 is also configured to engage the electrical coupling between the camera module 220 and the power module 240. For example, the camera module 220 electrical coupler may be disposed on the illustrated bottom end and the power module camera electrical coupler may be disposed on the interior bottom of the cylindrical recess. Therefore, the positioning of the camera module 220 within the recess of the power module 240 will automatically engage the electrical coupling therebetween. Unlike the first embodiment, the electrical coupling between the camera module 220 and the power module 240 also causes the camera module to transfer data from the camera module 220 memory to the power module 240. The power module 240 may then wirelessly transmit 280 the data to the PCD 260. The power module 240 may optionally be configured to also record the data on the power module's 240 memory. It will be appreciated that the wireless transmission 280 between the power module 240 and the PCD 260 may be two-way or one-way. A two-way wireless communication may include the ability for the PCD 260 to alter the functionality of the camera module 220 and/or the power module 240.

It will be appreciated that embodiments of the camera module may incorporate processing of a raw video stream as captured by the image sensor. The steps may include demosiacing, color correction, gamma correction, local contrast enhancement, noise filtering, and sharpening. Video compression may be employed prior to saving the video stream to storage. Video processing and compression are typically the most power intensive operations for a video camera. In order to save power in the camera module, and thus reduce its size, some or all of the processing and compression may be moved to the power module or the PCD. In one embodiment, the camera module would only store raw image sensor data and the power module and/or the PCD would do all the video processing and compression. Alternatively, the camera module may perform only preliminary processing and compression. For example, the camera module may only process motion JPEG to eliminate the need for a DRAM chip on the camera module. In this scenario, the power module and/or the PCD may perform the secondary processing and compression such as completing the compression of the stream. Alternatively, the camera module may perform the majority of the processing and compressing while some minor final processing such as Electronic Image Stabilization (EIS) is performed by the power module and/or PCD.

It should be noted that various alternative system designs may be practiced in accordance with the present invention, including one or more portions or concepts of the embodiment illustrated in FIG. 1 or described above. Various other embodiments have been contemplated, including combinations in whole or in part of the embodiments described above.

What is claimed is:

1. A wireless external camera system for use with a portable computer device comprising:
a portable computer device including at least one of a smartphone, tablet, tablet phone having a total volume smaller than twenty cubic inches;
a camera module having an outer dimension smaller than three cubic inches, wherein the camera module includes an electrical coupler, secondary battery, lens, image sensor, circuit board, and microphone, and wherein the camera module is configured to generate data from at least one of the image sensor or microphone;
a power module having an outer dimension smaller than twenty cubic inches, wherein the power module includes a primary battery, an electrical input, and a camera receptacle, and wherein the electrical input is configured to receive a direct current to charge the primary battery, and wherein the battery receptacle includes a physical camera receptacle and an electrical camera coupler;
a coupled state includes disposing the camera module within the physical camera receptacle and an electrical coupling between the electrical coupler of the camera module and the electrical camera coupler of the power module;
a separated state includes physically separating the camera module from the power module;
wherein the portable computer device is configured to wirelessly receive the data generated by the camera module; and
wherein the camera module further includes a wireless communication module, and wherein the camera module is configured to transmit the data to the portable computer device in the separated state.

2. The system of claim 1, wherein the camera module further includes a memory module configured to record the data.

3. The system of claim 1, wherein the camera module includes a substantially cylindrical positive outer shape and the physical camera receptacle of the power module includes a substantially cylindrical negative shape corresponding to the substantially cylindrical positive outer shape of the camera module.

4. The system of claim 3, wherein the electrical camera coupler of the power module is disposed on a substantially flat bottom surface of the substantially cylindrical negative shape of the physical camera receptacle.

5. The system of claim 3, wherein the electrical camera coupler of the power module is disposed on a curved lateral surface of the substantially cylindrical negative shape of the physical camera receptacle.

6. The system of claim 3, wherein the electrical camera coupler includes two electrically independent electrical couplers.

7. The system of claim 1, wherein the coupled state includes partially disposing the camera module within the physical camera receptacle such that a portion of the camera module is three dimensionally external of the power module.

8. The system of claim 7, wherein the portion of the camera module that is three dimensionally external of the power module, in the coupled state, extends at least half an inch from the power module.

9. The system of claim 1, wherein the physical camera receptacle of the power module includes a volume that is less than ninety percent of a volume of the camera module.

10. A wireless external camera system for use with a portable computer device comprising:
a portable computer device including at least one of a smartphone, tablet, tablet phone having a total volume smaller than twenty cubic inches;
a camera module having an outer dimension smaller than three cubic inches, wherein the camera module includes an electrical coupler, secondary battery, lens, image sensor, circuit board, and microphone, and wherein the camera module is configured to generate data from at least one of the image sensor or microphone;
a power module having an outer dimension smaller than twenty cubic inches, wherein the power module includes a primary battery, an electrical input, and a camera receptacle, and wherein the electrical input is configured to receive a direct current to charge the primary battery, and wherein the battery receptacle includes a physical camera receptacle and an electrical camera coupler;
a coupled state includes disposing the camera module within the physical camera receptacle and an electrical coupling between the electrical coupler of the camera module and the electrical camera coupler of the power module;
a separated state includes physically separating the camera module from the power module;
wherein the portable computer device is configured to wirelessly receive the data generated by the camera module; and
wherein the camera module further includes a wireless communication module, and wherein the camera module is configured to automatically transmit the data to the portable computer device in the separated state.

11. The system of claim 1, wherein the coupled state includes electrically transmitting current from the primary battery of the power module to the secondary battery of the camera module via the electrical coupling between the electrical coupler of the camera module and the electrical camera coupler of the power module.

12. A wireless external camera system for use with a portable computer device comprising:
a portable computer device including at least one of a smartphone, tablet, tablet phone having a total volume smaller than twenty cubic inches;
a camera module having an outer dimension smaller than three cubic inches, wherein the camera module includes an electrical coupler, secondary battery, lens, image sensor, circuit board, and microphone, and wherein the camera module is configured to generate data from at least one of the image sensor or microphone;
a power module having an outer dimension smaller than twenty cubic inches, wherein the power module includes a primary battery, an electrical input, and a camera receptacle, and wherein the electrical input is configured to receive a direct current to charge the primary battery, and wherein the battery receptacle includes a physical camera receptacle and an electrical camera coupler;
a coupled state includes disposing the camera module within the physical camera receptacle and an electrical coupling between the electrical coupler of the camera module and the electrical camera coupler of the power module;
a separated state includes physically separating the camera module from the power module;
wherein the portable computer device is configured to wirelessly receive the data generated by the camera module; and
wherein the camera module further includes a memory module configured to record the data;
wherein the power module further includes a wireless communication module, and wherein the power module is configured to receive the data from the camera module in the coupled state, and wherein the data is wirelessly transmitted to the portable computer device in the coupled state.

13. The system of claim 12, wherein the power module further includes a memory module configured to record the data from the camera module in the coupled state.

14. The system of claim 12, wherein the camera module includes a substantially cylindrical positive outer shape and the physical camera receptacle of the power module includes a substantially cylindrical negative shape corresponding to the substantially cylindrical positive outer shape of the camera module.

15. The system of claim 14, wherein the electrical camera coupler of the power module is disposed on a substantially flat bottom surface of the substantially cylindrical negative shape of the physical camera receptacle.

16. The system of claim 14, wherein the electrical camera coupler of the power module is disposed on a curved lateral surface of the substantially cylindrical negative shape of the physical camera receptacle.

17. The system of claim 12, wherein the coupled state includes partially disposing the camera module within the physical camera receptacle such that a portion of the camera module is three dimensionally external of the power module.

18. The system of claim 17, wherein the portion of the camera module that is three dimensionally external of the power module, in the coupled state, extends at least half an inch from the power module.

19. The system of claim 18, wherein the physical camera receptacle of the power module includes a volume that is less than ninety percent of a volume of the camera module.

20. The system of claim 12, wherein the power module is configured to automatically transmit data to the portable computer device via the wireless communication module in the coupled state.
